(19) United States
(12) Patent Application Publication
(10) Pub. No.: US 2022/0134776 A1
(43) Pub. Date: May 5, 2022

(54) PRINTING SYSTEM

(71) Applicant: Kateeva, Inc., Newark, CA (US)

(72) Inventors: Alexander Sou-Kang KO, Santa Clara, CA (US); Christopher BUCHNER, Sunnyvale, CA (US); Eashwer KOLLATA, Fremont, CA (US); Karl Andrew NORDHOFF, Cupertino, CA (US); Patrick SULLIVAN, Pleasanton, CA (US); Digby PUN, San Jose, CA (US); Gregory LEWIS, Mountain View, CA (US)

(73) Assignee: Kateeva, Inc., Newark, CA (US)

(21) Appl. No.: 17/452,566

(22) Filed: Oct. 27, 2021

Related U.S. Application Data
(60) Provisional application No. 63/108,853, filed on Nov. 2, 2020.

(51) Int. Cl. B41J 3/54; B41J 2/045; B41J 2/185; B41J 25/304

(52) U.S. Cl. CPC B41J 3/543; B41J 25/304; B41J 2/185; B41J 2/0456

(57) ABSTRACT

A printing system is described herein. The printing system has a massive base disposed on a flotation support, a flotation substrate support disposed on the base, a print support comprising a printhead assembly support and an auxiliary support, a printhead assembly coupled to the printhead assembly support, and a printhead supply assembly coupled to the auxiliary support.

### CROSS-REFERENCE TO RELATED APPLICATIONS

This patent application claims benefit of U.S. Provisional Patent Application Ser. No. 63/108,853 filed Nov. 2, 2020, which is incorporated herein by reference.

### BACKGROUND

Industrial inkjet printers are used to apply materials to large substrates to form devices of all kinds. The substrates can be rigid or flexible, thick or thin, and can be made of an array of materials. The most common types of substrates used in this way are substrates made of various types of glass, which are processed to make electronic displays such as televisions and displays for smart phones.

Such displays are typically made on a large sheet of glass, with many devices mapped out on the sheet. Making multiple devices in one processing pass achieves economy of scale, reducing the unit price of the individual devices. There is a continuing need to enlarge the processing format for display manufacture, which also applies to manufacture of other electronic devices on other substrates.

For display devices, in particular, the promise of increasing economy of scale is challenged by uniformity problems that mount with increasing scale. Manufacturing processes for display devices often result in visible artifacts, such as lines and patterns, in the device that render the device unusable. These problems have been largely solved in current commercial printers, but increasing scale always invites new uniformity problems.

Naturally, as larger substrates with larger print areas are processed, printing takes longer. There is also the parallel need to speed up manufacture of single substrates.

Additionally, there is always a trend in display devices toward higher resolution complicating the drive toward larger format manufacturing. Reducing the size of drops printed on a substrate always comes with the possibility of new uniformity problems. Thus, there is a need to increase the scale and speed of commercial inkjet printing, while also increasing the resolution of commercial inkjet printing, all while maintaining uniform device construction without visible defects.

### SUMMARY

Embodiments described herein provide an inkjet printer, comprising a massive base disposed on a flotation support; a flotation substrate support disposed on the base; a print support comprising a printhead assembly support and an auxiliary support; a printhead assembly coupled to the printhead assembly support; and a printhead supply assembly coupled to the auxiliary support.

Other embodiments described herein provide an inkjet printer, comprising a massive base disposed on a flotation support; a flotation substrate support disposed on the base; a print support comprising a printhead assembly support and an auxiliary support; a plurality of imaging devices movably coupled to a linear track mounted to the printhead assembly support; a printhead assembly coupled to the printhead assembly support; and a printhead supply assembly coupled to the auxiliary support.

Other embodiments described herein provide an inkjet printer, comprising a massive base disposed on a flotation support; a flotation substrate support disposed on the base; a print support comprising a printhead assembly support and an auxiliary support; a plurality of imaging devices movably coupled to a linear track mounted to the printhead assembly support; a printhead assembly coupled to the printhead assembly support, the printhead assembly comprising a housing enclosing a supply unit at a first end of the housing and a plurality of print tiles at a second end of the housing; and a printhead supply assembly coupled to the auxiliary support.

### BRIEF DESCRIPTION OF THE DRAWINGS

FIG. 1 is an elevated corner view of an inkjet printer according to one embodiment.

FIG. 2A is an end view of the inkjet printer of FIG. 1.

FIG. 2B is a close-up view of a portion of the inkjet printer of FIG. 1.

FIG. 3A is a bottom view of a printhead assembly according to one embodiment.

FIG. 3B is a bottom view of a printhead assembly according to another embodiment.

FIG. 3C is a corner view of the interior of the printhead assembly of FIG. 3B.

FIG. 3D is a side view of the printhead assembly of FIG. 3B.

FIG. 4A is an elevated corner view of a tile of a printhead assembly according to one embodiment.

FIG. 4B is a disassembled view of the tile of FIG. 4A.

FIG. 4C is a partially disassembled top perspective view of a printhead assembly according to one embodiment.

FIG. 4D is a bottom view of the partially disassembled printhead assembly of FIG. 4C.

FIG. 5 is a flow schematic diagram of print material delivery to a printhead assembly according to one embodiment.

FIG. 6A is a lower perspective view of a print support with the printhead assembly of FIG. 3A according to one embodiment.

FIG. 6B is a detail view of imaging devices coupled to the print support of FIG. 6A according to one embodiment.

FIG. 6C is a cross-sectional view of a substrate imaging assembly according to one embodiment.

FIG. 7A is an elevated corner view of a containment structure for an inkjet printer according to one embodiment.

FIG. 7B is a schematic cross-sectional view of the printer of FIG. 1 and the containment structure of FIG. 7A.

FIG. 8A is a top view of a diagnostic unit for an inkjet printer according to one embodiment.

FIG. 8B is a top view of a diagnostic unit for an inkjet printer according to another embodiment.

FIG. 8C is a detail view of a portion of the inkjet printer of FIG. 1 showing a drop placement analyzer according to one embodiment.

FIG. 8D is a close-up view of the drop placement analyzer of FIG. 8C.

### DETAILED DESCRIPTION

An inkjet printer is described herein that has a massive base with flotation support, a flotation substrate support disposed on the base, a print support comprising a printhead assembly support and an auxiliary support, a printhead assembly coupled to the printhead assembly support, and a printhead supply assembly coupled to the auxiliary support. The description herein refers to certain figures. Supporting disclosure is also included in an Appendix.

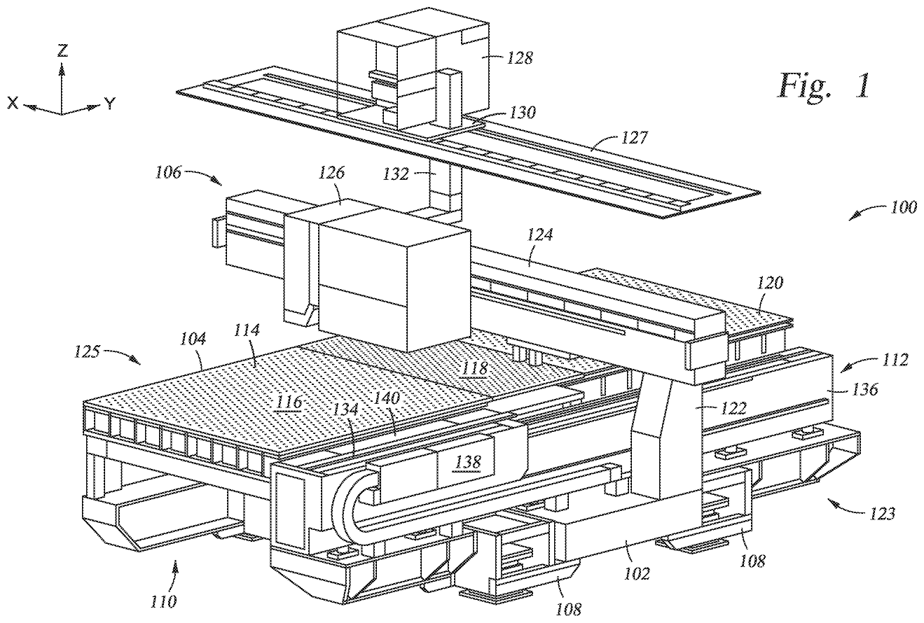

FIG. 1 is an elevated corner view of an inkjet printer 100 according to one embodiment. The inkjet printer 100 has a massive base 102 with a substrate support 104 and a print support disposed 106 on the base 102. The substrate support 104 is a flotation support that provides a gas cushion to support a substrate above the surface of the substrate support without contacting the surface. The base 102, in this case, is disposed on two flotation supports 108 that float the base on a gas cushion.

The substrate support extends from a first end 110 of the printer 100 to a second end 112 of the printer, opposite from the first end 110. Gas for the flotation support is supplied to a plurality of openings 114 in the surface of the substrate support 104. The substrate support 104, in this case, has three sections. In a first section 116, the openings 114 are for gas output to float the substrate above the surface of the substrate support 104. In a second section 118, a first portion of the openings 114 are for gas output while a second portion of the openings 114 are for gas input. The second section thus has capability to control an aspect of the gas, for example pressure or volume, providing the cushion to support the substrate in the second section. A gas supply (not shown) is coupled to the gas output openings 114 of the second section 118, while a vacuum source (not shown) is coupled to the gas input openings 114. A controller controls one or both of the gas supply and the vacuum source to target an aspect of the gas cushion for precise height control of the substrate in the second section 118. Print material is dispensed onto the substrate while the substrate is located adjacent to the second section 118, so the substrate height control provides deposition precision. A third section 120 of the substrate support 104 is similar to the first section 116, with the openings 114 providing gas output in the surface thereof. The second section 118 is located between the first and third sections 116 and 120, so the first and third sections 116 and 120 can be used to stage and manipulate substrates for printing in the second section 118.

The print support 106 comprises a first stand 122 located on a first side 123 of the substrate support 104 and a second stand (not shown) located on a second side 125 of the substrate support 104 opposite from the first side 123, each stand substantially adjacent to the second section 118 of the substrate support 104. The first stand 122 is disposed on the base 102 at the first side 123 of the substrate support. The second stand, substantially identical to the first stand (and not visible in FIG. 1), is disposed on the base 102 at the second side 125 of the substrate support 104. The substrate support 104 thus extends between the first stand 122 and the second stand, with the second section 118 of the substrate support 104 being located substantially between the two stands. Each of the first stand 122 and the second stand is shown resting directly on, in contact with, a surface of the base 102, but a support member may be disposed between each stand and the base 102. For example, a vibration dampening member may be disposed between each stand and the base 102. Each stand is fastened to the base 102. In this case, each stand has a plurality of bores formed in a lower surface of the stand to receive fasteners, such as bolts, disposed through the base 102 and into the bores. The bores and fasteners are omitted from FIG. 1 to simplify the figure. As shown here, one or two edges of each stand may be aligned with an edge of the base 102, or the stands may be positioned on the base 102 according to any plan.

The substrate support has a long dimension, running from the first end 110 to the second end 112, which generally defines an axis referred to as the “y” axis. The first and second stands extend from the base 102 in a direction that defines an axis referred to as the “z” axis, which is perpendicular to the y axis.

The print support 106 comprises a printhead assembly support 124 that rests on the first and second stands. The printhead assembly support 124 extends in a direction that defines an axis referred to as the “x” axis, which is perpendicular to the y axis and the z axis. A printhead assembly 126 is coupled to the printhead assembly support 124 by a printhead traveler (not shown) that provides movement of the printhead assembly 126 along the printhead assembly support 124. The printhead assembly 126 thus moves along the x axis.

The print support 106 also comprises a printhead auxiliary support 127 that extends in the x-axis direction, substantially parallel to the printhead assembly support 124. The printhead auxiliary support 127 is located near the printhead assembly support 124, in this case directly above the printhead assembly support 124. A printhead supply assembly 128 is coupled to the printhead auxiliary support 127. The printhead supply assembly 128 comprises a printhead supply traveler 130 that couples the printhead supply assembly 128 to the printhead auxiliary support 127. The printhead supply assembly 128 is fluidly and electrically coupled to the printhead assembly 126 to supply material, electric power, and electric signals to the printhead assembly 126.

The printhead traveler comprises a gas cushion bearing (not shown) to provide frictionless support for the printhead assembly 126 on the printhead assembly support 124. The printhead traveler is thus coupled to the printhead assembly support 124 by a gas cushion that allows substantially frictionless, vibration-free, and particle-free movement of the printhead assembly 126 along the printhead assembly support 124. The printhead supply traveler 130 is coupled to the printhead auxiliary support 127 by a linear bearing (not shown), which may be any kind of linear bearing, such as a linear ball bearing, roller bearing, or gas cushion. The printhead traveler and the printhead supply traveler 130 move along their respective supports 124 and 127 independently, but a controller controls actuators that provide motive force to each traveler to maintain proximity of the two travelers within a tolerance of a few millimeters.

A conduit 132 is connected to the printhead supply assembly 128 and the printhead assembly 126. The conduit houses fluid supply conduits and electrical connectors that run between the printhead supply assembly and the printhead assembly. The fluid supply conduits carry print material between the printhead supply assembly and the printhead assembly, to and from the printhead assembly. The conduit is flexibly connected between the two assemblies to prevent applying unwanted forces to misalign or otherwise mis-position the printhead assembly.

Locating the printhead supply assembly along a separate support from the printhead assembly, and maintaining a physical separation between the printhead assembly support and the printhead supply support isolates the printhead from vibrations that might emanate from the printhead supply assembly, for example from pumps, valves, or compressors that might be used to circulate print material to and from the printhead assembly. For example, while the printhead assembly support is physically connected to the base, which is supported on a gas cushion, the printhead supply support is physically connected to a frame of the printer, which rests on the ground or other support, and is not physically connected to the base or the printhead assembly support. The physical separation also provides the possibility to sequester particles generated by components of the printhead supply assembly, preventing the particles from impacting the print process. Thus, frictionless, non-contact bearing is not required for the print supply assembly. Finally, remote location of the printhead supply assembly from the printhead assembly can reduce the effect of heat generated by printhead components of the printhead assembly on fluids supplied through the printhead supply assembly.

A substrate handler 134 is coupled to a substrate handler support 136 that extends in a direction parallel to they axis. The substrate handler support 136 is located along the first side 123 of the substrate support and extends between the first stand 122 and the substrate support 104. The substrate handler 134 comprises a carriage member 138 and a substrate contact member 140 coupled to the carriage member. The carriage member 138 couples the substrate handler 134 to the substrate handler support 136 and provides movement of the substrate handler 134 along the substrate handler support 136 in the y axis direction. The substrate contact member 140 engages with a substrate disposed on the substrate support 104, and movement of the substrate handler 134 moves the substrate along the substrate support surface, while floating on the gas cushion, in the y-axis direction. In this way, the substrate handler 134 positions the substrate for dispensation of print material from the printhead assembly 126 onto target areas of the substrate.

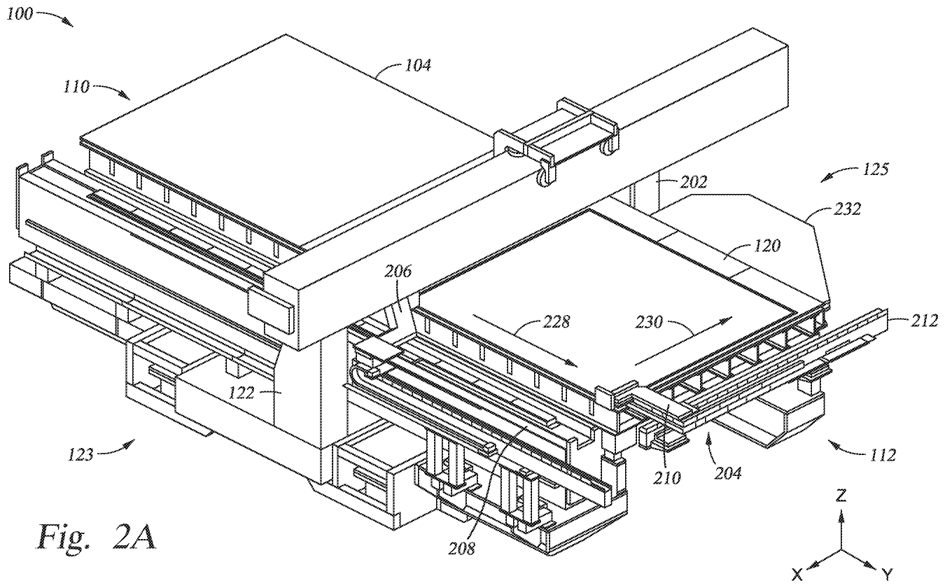

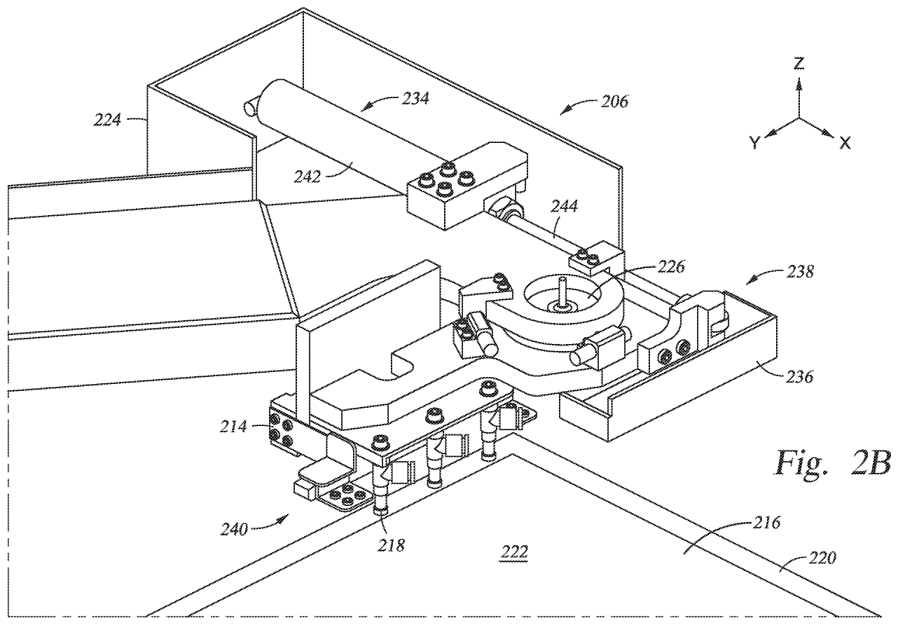

FIG. 2A is a view of the inkjet printer 100 of FIG. 1 showing the second end 112 of the printer 100. As noted above, the substrate support 104 extends from the first end 110 to the second end 112. In FIG. 2A, a second stand 202 is visible at the second side 125 of the substrate support 104, so the substrate support 104 can be seen extending between the first stand 122 and the second stand 202. Substrate input and output can both be at the first end 110 of the printer 100, or substrate output can be at the second end 112 of the printer 100, while substrate input is at the first end 110.

The substrate support 104 includes a substrate rotation assembly 204 at the second end 112 of the printer 100. The substrate rotation assembly 204 comprises two linear actuators coupled to supports extending along the x and y axes, respectively. A y-axis rotator 206 is coupled to a y-axis rotator support 208, and an x-axis rotator 210 is coupled to an x-axis rotator support 212. FIG. 2B is a close-up view of a portion of the y-axis rotator 206. The rotator 206 has an attachment member 214 that engages with a substrate to securely hold and manipulate the substrate during rotation thereof. A substrate 216 is shown engaged with the attachment member 214 in FIG. 2B. The attachment member 214 has a plurality of suction members 218 that contact, and attach to, the substrate 216 at an edge region 220 thereof that is outside an active region 222 of the substrate 216 to avoid any contact with devices or structures formed in the active region 222 that may be damaged by contact.

The attachment member 214 is shown in FIG. 2B in a “home” position. The “home” position enables the attachment member 214 to engage with the substrate 216 prior to rotation of the substrate 216, ensuring the suction members 218 engage with the substrate in the edge region 220 thereof. In the case of the y-axis rotator 206, the suction members 218, and the attachment member 214, generally extend in a longitudinal direction that is substantially parallel to the y-axis direction when the attachment member 214 is in the “home” position, so in the “home” position the suction member 218 engage with the edge region 220 of the substrate 216 along a line substantially parallel to the y-axis direction.

The attachment member 214 is rotatably coupled to a support arm 224 of the rotator 206 by a rotary coupling 226. The rotary coupling 226 allows the attachment member 214 to rotate with respect to the support arm 224 while the support arm 224 is moved linearly along the y-axis rotator support 208 (FIG. 2A) in a direction parallel to the y-axis direction. The support arm 224 does not rotate, so as the attachment member 214 rotates, the angle defined by the attachment member 214 with respect to the support arm 224 changes from a 90° angle at the “home” position to a 180° angle at the fully rotated position. At the fully rotated position the attachment member 214 extends in a direction parallel to the x-axis direction outward from the rotary coupling 226 and away from the support arm 224. The x-axis rotator 210 has a similar attachment member 214 with movement paradigm oriented for movement of the rotator 210 along the x-axis, with commensurate movement of the attachment member 214 thereof.

The attachment member 214 is not specifically actuated to rotate the substrate 216. The attachment members 214 of the x- and y-axis rotators 206 and 210 are passively rotatable by operation of the rotary coupling 226. Once attached to the substrate 216, the rotators move linearly along their respective axes to rotate the substrate 214 a quarter-turn. Movement of the support arm 224 of each rotator, coupled with unconstrained rotation of the attachment member 214 about the rotary coupling 226 of each rotator, rotates the substrate 216.

Referring again to FIG. 2A, at the same time the y-axis rotator 206 is coupled to the substrate 216 and moving along the y-axis rotator support 208 in a direction parallel to the y-axis direction, as denoted by arrow 228, the x-axis rotator 210 is similarly coupled to the substrate 216 by a similar gripper member 214 with suction members 218 oriented, in a “home” position, to extend in a direction substantially parallel to the x-axis direction and engage with the substrate 216 at an edge region that extends in the x-axis direction. The x-axis rotator 210 has a similar rotary coupling 226 that couples the attachment member 214 thereof to a support arm 224 thereof, and linear movement of the x-axis rotator 210 along the x-axis rotator support 212 causes rotation of the attachment member 214. At the same time the y-axis rotator 206 moves according to the arrow 228 along the y-axis rotator support 208, the x-axis rotator 210 moves in a direction parallel to the x-axis, as denoted by arrow 230, along the x-axis rotator support 212. Unconstrained rotation of the gripper members 214 allows rotation of the substrate 216 in a controlled fashion such that the substrate 216 ends in a position, rotated 90°, that is suitable for re-engagement with the printer 100.

To accomplish the rotation, the substrate handler 134 (FIG. 1) positions the substrate 216 at the third section 120 of the substrate support 104. The attachment members 214 of the rotators 206 and 210 attach to the substrate in the edge regions 220 (FIG. 2B), which serve as exclusion zones, of the substrate 216, so that the active region 222 of the substrate 216 is unaffected by the attachment. The substrate handler 134 disengages with the substrate 216 during rotation. After rotation, the substrate handler 134 re-engages with the substrate and the rotators 206 and 210 disengage with the substrate 216. As noted above, the motion of the rotators 206 and 210 rotate the substrate 216 about 90° from a first position engageable with the substrate handler 134 to a second position engageable with the substrate handler 134. During the rotation, the substrate 216 is continuously supported by a gas cushion above the third section 120 of the substrate support 104. At no time during substrate rotation is the substrate unconstrained by a handling device. The rotation mechanism used delivers the substrate 216 in a rotated position with an edge of the substrate in the same proximity with the substrate handler 134 as before the rotation, such that the substrate handler 134 does not need to be repositioned in a direction perpendicular to its axis of motion to re-engage with the substrate 216.

The rotation assembly 204 can rotate the substrate in a first rotational direction and in a second rotational direction opposite from the first rotational direction. If the rotation described above is the first rotational direction, where the rotators move as shown by the arrows 228 and 230 of FIG. 2A, the rotation assembly 204 can be operated in an exactly opposite manner to rotate the substrate in a second rotational direction, opposite from the first rotation direction. Thus, the rotation assembly can rotate substrates between portrait and landscape orientation, clockwise or counter-clockwise without limitation.

As noted above, the substrate 216 is continuously supported by a gas cushion at the third section 120 of the substrate support 104. The third section 120 has a lateral extension 232 at the second side 125 of the substrate support 104 to provide continuous support for the substrate 216 during rotation. As a corner of the substrate 216 protrudes beyond the edge of the third section 120, the lateral extension 232 continues the gas cushion support for the substrate 216 until the corner of the substrate 216 re-orients onto the third section 120. The lateral extension 232 has openings for gas flow to provide gas cushion at the lateral extension in a manner substantially continuous with the gas cushion of the third section 120. A gas source is coupled to the openings of the lateral extension 232 to provide the gas cushion. The gas source coupled to the lateral extension 232 may be the same gas source that is coupled to the third section 120, or a different gas source. The gas sources are not shown in FIGS. 1-2B.

Referring again to FIG. 2B, each rotator 206 and 210 has a positioner 234 coupled between the support arm 224 and the attachment member 214. The positioner 234 is a linear actuator that couples to a manipulator 236 of the attachment member 214, which in this case is located at a first end 238 of the attachment member 214, while the suction members 218 are located near a second end 240 of the attachment member 214, opposite from the first end 238. Here, the positioner 234 comprises a hydraulic cylinder 242 and rod 244, the cylinder 242 being coupled to the support arm 226 and the rod 244 being coupled to the manipulator 236. Any suitable linear actuator can be used as a positioner. The positioner 234 generally positions the attachment member 214 with respect to the support arm 224 when the attachment member 214 is not engaged with a substrate. For example, prior to engaging with a substrate, the attachment member 214 is positioned at a “home” position, and after disengaging with a substrate, the attachment member 214 may be returned to the “home” position.

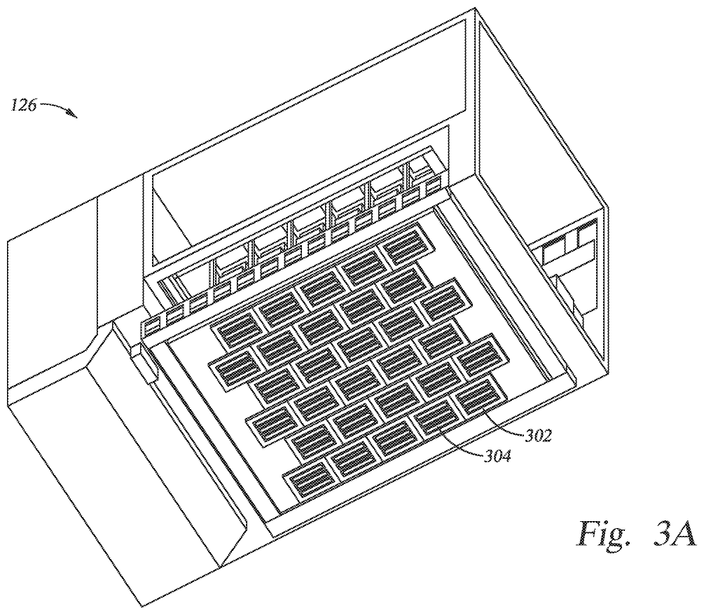

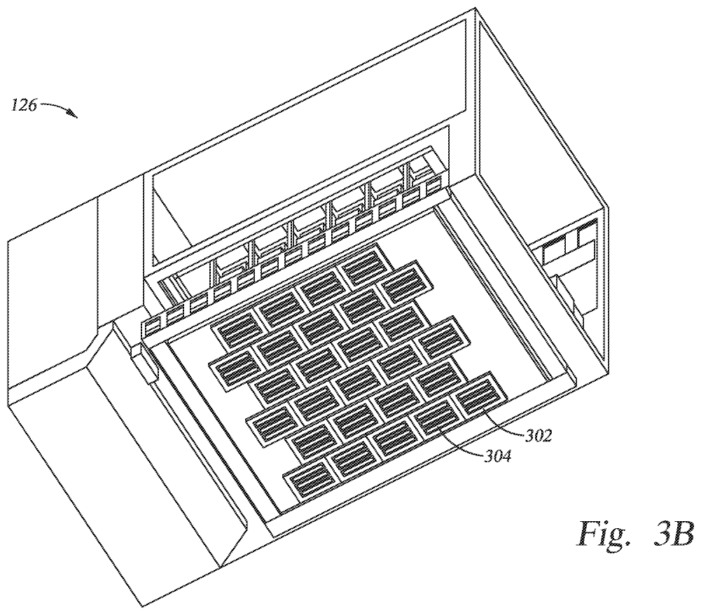

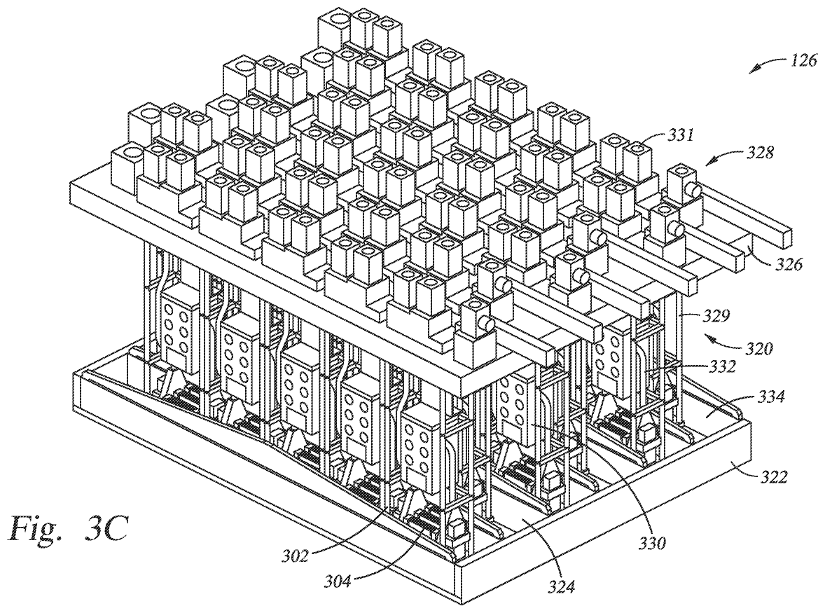

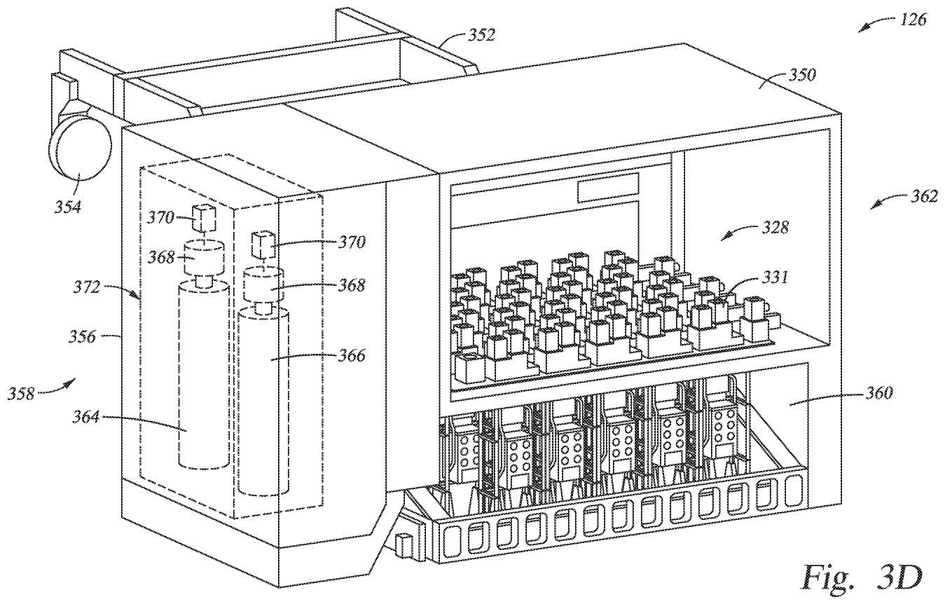

FIG. 3A shows configuration of the printhead assembly 126 according to one embodiment. The printhead assembly comprises a plurality of tiles 302 arranged in rows in a staggered arrangement. Each tile 302 has three printheads 304, with each printhead 304 having a plurality of nozzles. The nozzles are too small in the view of FIG. 3A to be specifically visible. In the configuration shown in FIG. 3A, there are six rows of five tiles 302 each, for a total of 30 tiles 302 or 90 printheads 304. If each printhead 304 has 256 nozzles, such a configuration supports a total of 23,040 print nozzles available for printing. The tiles 302 are arranged in a staggered configuration, with a center line of each tile aligned with an end of one, two, or four neighboring tiles. The tiles 302 of the printhead 126 face the substrate support 104 in the printer 100 shown in FIG. 1, so print material ejected from the nozzles of the printheads 304 travels toward a substrate disposed on the substrate support 104 at the second section 118 thereof and impinges a print surface of the substrate.

Other configurations of a printhead are possible. FIG. 3B shows configureation of the printhead assembly 126 according to another embodiment. The embodiment shown in FIG. 3B has print tiles 302 that are arranged in six rows that alternate between a row having five tiles 302 in the row and a row having four tiles 302 in the row, for a total of 27 tiles. If the printheads 304 of FIG. 3B have 256 nozzles each, the printhead assembly 126 of FIG. 3B has 20,736 nozzles. As in FIG. 3A, the tiles 302 in FIG. 3B are likewise arranged in a staggered configuration. The different tile configurations can be selected based on printing needs. For example, where multiple print materials may need to be deposited on a substrate, a printhead assembly with more nozzles offers more ways to deposit the multiple materials. Alternately, where fewer materials are deposited, a printhead assembly with fewer nozzles may offer all the flexibility that is needed to deposit the materials while allowing for faster processing and print plan rendering.

FIG. 3C shows an interior structure of the printhead assembly 126. The view of FIG. 3C shows portions of the internal fluid delivery assembly of the printhead assembly 126 from the top, where the fluid supply components of the printhead assembly 126 are located. Each tile 302 of the printhead assembly 126 further comprises print material delivery components, pneumatic control components, and electronic control components arranged in a structure whose shape and dimension is substantially controlled by the geometry of printhead positioning in the tile 302. Each tile 302 of the printhead assembly is held in a tile support structure 320 made from a material having low coefficient of thermal expansion to avoid or minimize thermal distortions of the positions of printheads and print nozzles. A support plate 322 allows for coupling of supply and return manifolds for print material to the tiles 302. The support plate 322 includes a plurality of partitions 324 that guide positioning of the print material manifolds of each tile and for positioning and engagement of electrical connections of the tiles 302.

The printhead assembly 126 comprises a supply plate 326 and the support plate 322, which are oriented in substantially parallel arrangement. Each tile 302 extends substantially from the support plate 322 to the supply plate 326. An interface assembly 328 is coupled to the supply plate 326 adjacent to each tile 302 to supply liquid, gas, and electricity to the tile 302. Each tile 302 comprises a cage 329 that extends from the support plate 322 to the supply plate 326 and provides structural containment and strength to the tile 302, enabling handling of the tile 302 as a unit. Each tile 302 generally has a digital unit 330, centrally disposed within the cage 329 to provide electronic control and data handling for the tile 302, and fluid conduits 332 disposed within the cage 329 and around the digital unit 330 to provide fluid communication from the interface assembly 328 to the printheads 304 of the tile 302. The interface assembly 328 comprises valves 331 that control flow of print material into and out of each tile 302. The valves 331 for each tile 302 comprise at least a supply valve to control flow of print material into the tile 302 and a return valve to control flow of print material out of the tile 302. The cage 329 positions the tile 302 in a furrow 334, which is defined by the partitions 324, of the support plate 322 so the printheads 304 of the tiles 302 are accurately positioned within the printhead assembly 126. The furrows 334 define the rows into which the tiles 302 are arranged.

FIG. 3D shows another view of the printhead assembly 126 from an end perspective. The printhead assembly 126 comprises a printhead housing 350 and a printhead carriage 352 coupled to the housing 350. The printhead carriage 352 is a gas support carriage that couples to the printhead support 124 (FIG. 1) and supports the printhead assembly 126 using a gas cushion formed between the printhead carriage 352 and the printhead support 124. The printhead carriage 352 comprises a plurality of gas supports 354 (one of which is visible in FIG. 3D) to provide non-contact support between the printhead carriage 352 and the printhead support 124. The printhead assembly 126 comprises a supply unit 356 located at a first end 358 of the housing 350 and a printhead compartment 360 that extends from the supply unit 356 to a second end 362 of the housing opposite from the first end 358. The supply unit 356 and the compartment 360 have substantially equal height, in this case, such that the housing 350 is shaped like a rectangular prism. The supply unit 356 contains supply hardware that transfers print material to and from the valves 331 of the interface assembly 328.

The supply unit 356 includes at least one supply reservoir 364 and one return reservoir 366. The supply reservoir 364 moderates supply of print material to the interface assembly 328 and the return reservoir 366 moderate return of print material from the interface assembly 328. Flow of print material to and from each of the supply reservoir 364 and the return reservoir 366 is controlled by a valve 368, which may be pneumatically actuated. Use of pneumatic valves reduces heat from electronics that can build up in the inventory of print material in the supply and return reservoirs 364 and 366. Pressure of the print material being delivered to the printhead assembly 126 is very closely controlled by a pressure regulator 370, one for each of the supply and return reservoirs 364 and 366, which regulates pressure of a gas cap in each of the supply and return reservoirs 364 and 366. In this case, the supply and return reservoirs 364 and 366 operate using dip tubes to extract print material. The pressure regulators 370 adjust gas cap pressure within the supply and return reservoirs 364 and 366 to compensate for variation in head pressure of print material above the respective dip tube inlets. The pressure regulators 370 may be adjusted based on a sensed pressure of the print material in the dip tubes or elsewhere in the supply and return circuits, or based on a sensed level within the reservoirs 364 and 366. The reservoirs 364 and 366, the valves 368, and the pressure regulators 370 are assembled into a cassette 372, in this case, for ease of maintenance.

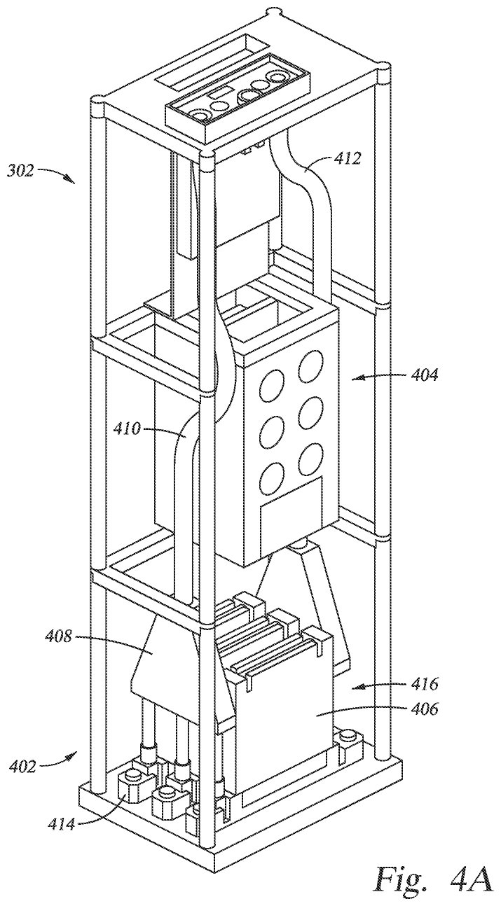

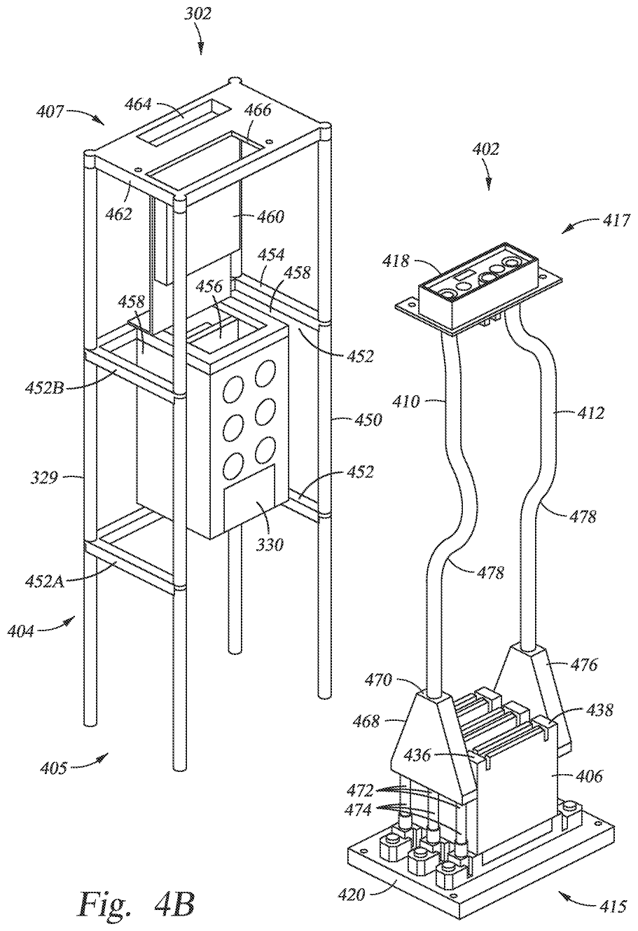

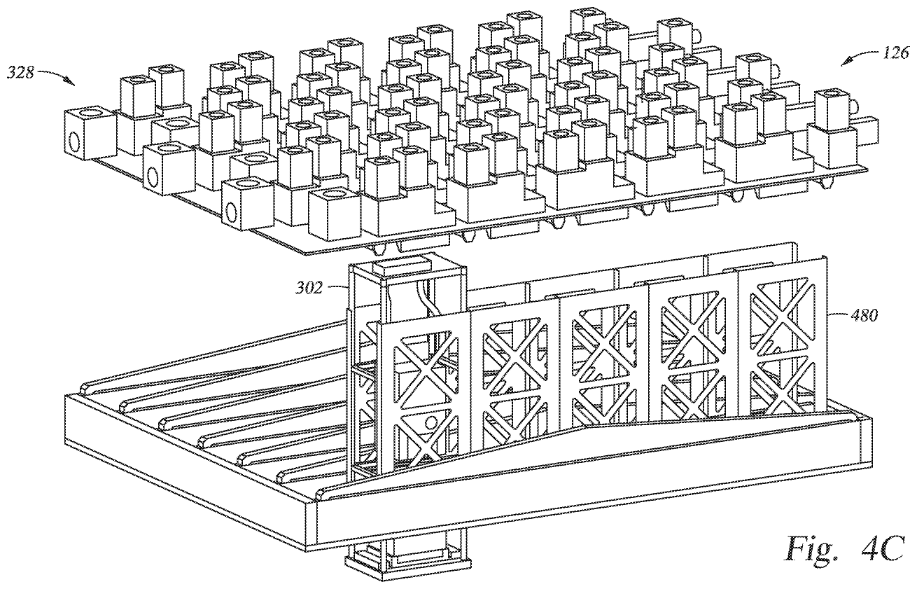

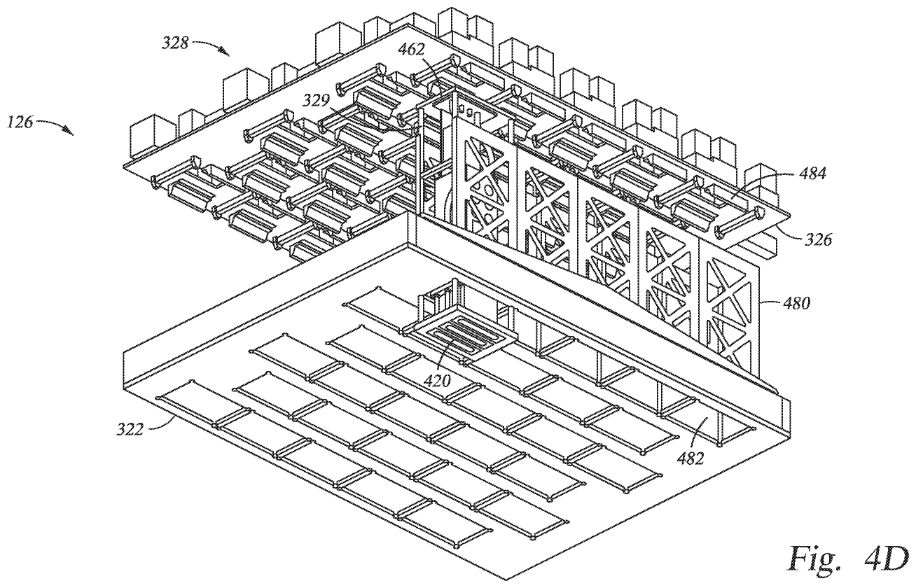

FIG. 4A shows the construction of a tile 302 for the printhead assembly, according to one embodiment. Each tile has a fluid member 402 and an electronic member 404 that fit together to form the tile. The fluid member 402 has three printheads 406 fluidly coupled to a fluid conduit system 408 for delivering print material to the printheads 406 and returning material from the printheads 406. The fluid conduit system 408 has a supply conduit 410 and a return conduit 412, the supply conduit 410 fluidly coupled to a first side 414 of the printheads 406 and the return conduit 412 fluidly coupled to a second side 416 of the printheads 406 opposite from the first side 414. The electronic member 404 has a driver box 410 to house printhead drive circuitry and a connector 412 to provide electrical connection between the tile 400 and control circuitry (not shown) of the printer.

FIG. 4B is a disassembled view of the tile 302, showing the electronic member 404 and the fluid member 402 side-by-side. The electronic member 404 has a first end 405 and a second end 407 located opposite from the first end 405. A longitudinal axis of the cage 329 extends between the first and second ends 405 and 407. The electronic member 404 comprises the cage 329, which comprises four strength members 450 arranged in a rectangular configuration and extending, parallel one to the others, in a longitudinal direction of the tile 302. The cage 329 also comprises two web members 452, a first web member 452A and a second web member 452B, that couple to all the strength member 450 to provide structural rigidity to the cage 329. The web members 452 are each u-shaped members that extend linearly between adjacent strength members 450 along three sides of the rectangle defined by the strength member 450. Thus, each web member 452 extends between two adjacent strength members, turns a 90° corner and extends to a third strength member 450, turns another 90° corner and extends to the fourth strength member 450. Each web member 452 is flat, with a width of the web member 452 larger than a thickness of the web member 452, and each web member 452 has an interior edge with a curvature radius at each corner thereof. The first web member 452A is closer to the first end 405 of the electronic member 404 than the second end 407, while the second web member 452B is closer to the second end 407 than the first end 405. When the electronic member 404 is assembled with the fluid member 402, the first web member 452A is closer to the printheads 406 of the fluid member 402 than the second web member 4526.

An electronic support plate 454 is attached to the second web member 452B. The electronic support plate 454 extends across the cage 329 to all four strength members 450, and provides structural support and positioning for electronic elements of the tile 302 to make electrical connections. The electronic support plate 454 has a central opening 456 to facilitate making electrical connections through the electronic support plate 454. The electronic support plate 454 has cutouts 458 to allow routing of fluid conduits of the fluid member 402 from below the electronic support plate 454 to above the electronic support plate 454 without requiring the fluid conduits to extend outside the cage 329. Here, the cutouts 458 are on the same side of the electronic support plate 454, but the cutouts 458 could be at any convenient locations. It should be noted that the cutouts 458 are in the form of notches in the edge of the electronic support plate 454, but one or more of the cutouts 458 could be an opening through the electronic support plate 454 to allow passage of a fluid conduit. Here, when the fluid member 402 and the electronic member 404 are assembled together, fluid conduits of the fluid member 402, further described below, fit into the cutouts 458.

The digital unit 330 is attached to the electronic support plate 454 and is located between the electronic support plate 454 and the first web member 452A. A longitudinal axis of the digital unit 330 is aligned with a longitudinal axis of the cage 329. An electronic interface member 460 is attached to the electronic support plate 454, and is located between the electronic support plate 454 and the second end 407. An end plate 462 is attached to the four strength member 450 at the second end 407 of the electronic member 404. The end plate 462 provides structural support for electronic and fluid connections between the tile 302 and supply assemblies that supply fluids and electricity to the tile 302, such as the interface assembly 328. The end plate 462 has an electronics opening 464 for making electrical connection to the electronic interface member 460 and a fluid opening 466 for making fluid connection to the fluid member 402. Here, the electronics opening 464 is centered along one edge of the end plate 462, while the fluid opening 466 is positioned off-center with respect to all edges of the end plate 462.

The fluid member 402 has a first end 415 and a second end 417 opposite from the first end 415, the first end 415 of the fluid member 402 generally aligning with the first end 405 of the electronic member 404 and the second end 417 of the fluid member 402 generally aligning with the second end 407 of the electronic member 404. The printheads 406 are located at the first end 415 of the fluid member 402, and a fluid connector 418 is located at the second end 417 of the fluid member 402. The fluid connector 418 is fluidly coupled to the printheads 406 by the fluid conduit system 408, which extends from the first end 415 to the second end 417 of the fluid member 402. The fluid connector 418 fluidly couples to the valves 331 of the interface assembly 328 (FIG. 3C).

The printheads 406 are attached to a face plate 420, located at the first end 415 of the fluid member 402, that provides secure mounting for the tile 302 to the printhead assembly 126, along with openings to expose nozzles (not shown) of the printheads 406 at a nozzle surface (not shown) of the face plate 420. The printheads 406 are aligned at the face plate 420, so the nozzles of all the printheads 406 are disposed substantially in a plane at the nozzle surface of the face plate 420, and so opposite edges of the printheads 406 are aligned. The face plate 420 engages with the strength members 450 to complete the cage 329.

The printheads 406 are spaced apart along the face plate 420, with a constant uniform spacing between adjacent printheads 406 on the face plate 420. Each printhead 406 has a plurality of print nozzles, not visible in FIG. 4B, which are distributed along a longitudinal axis of the printhead 406 in one or more rows. The printheads 406 are spaced apart in a direction parallel to a lateral axis of each printhead 406, perpendicular to the longitudinal axis of each printhead 406. Each printhead has a first end 436 and a second end 438, opposite from the first end 436 along the longitudinal axis of the printhead 406.

The supply conduit 410 and the return conduit 412 are routed on opposite sides of the digital unit 330 between the printheads 406 and the fluid connector 418. The supply conduit 410 extends from the fluid connector 418 to a supply manifold 468 at the first end 436 of the printheads 406. The supply manifold 468 has a single inlet 470, and internally divides flow symmetrically into three portions at three outlets 472. An inlet conduit 474 fluidly couples each outlet 472 of the supply manifold 468 to the first end 436 of one of the printheads 406 to deliver print material to the printhead 406. The supply manifold 468 is triangular in shape, and is configured to deliver print material to each printhead 406 with essentially no difference in pressure drop so that ejection of print material from nozzles of the printheads 406 can be controlled precisely. An identical return manifold 476, with exit conduits (not visible), fluidly couples the second end 438 of each printhead 406 to the return conduit 412. Each of the supply conduit 410 and the return conduit 412 has a curved portion 478 to match the cutouts 458 of the electronic support plate 454 such that when the fluid member 402 is assembled with the electronic member 404, the fluid connector 418 fits into the fluid opening 466 and the supply and return conduits 410 and 412 fit into respective cutouts 458.

FIG. 4C is a partially disassembled top perspective view of the printhead assembly 126. An envelope 480 is disposed between the support plate 322 and the supply plate 326 for each tile 302 to guide installation of the tile 302 and connection of the tile 302 (connections of the fluid connector 418 and the electrical interface member 460) with the interface assembly 328. FIG. 4D shows the same view as FIG. 4C from the bottom. The assembled tile 302 is inserted through a tile opening 482 in the support plate 322 into the envelope 480 to connect to the interface assembly 328. The supply plate 326 has one or more landing guides 484 that protrude away from the supply plate 326 to engage with the top portion of the cage 329, for example with the end plate 462, such that the various fluid and electrical connections of the tile 302 connect securely as the tile 302 is seated in the printhead assembly 126. The face plate 420 of the tile 302 is attached to the support plate 322 to secure the tile 302 within the printhead assembly 126.

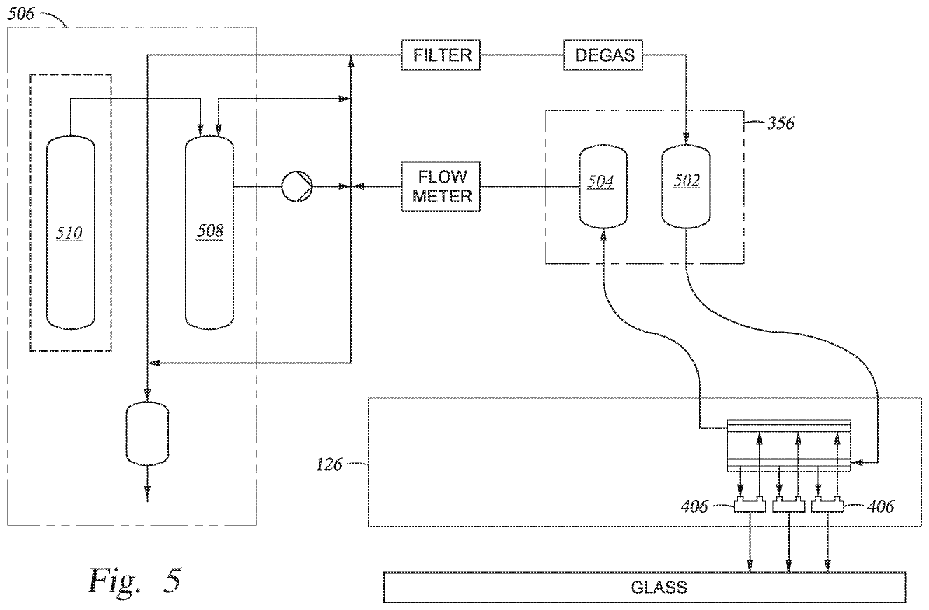

FIG. 5 describes delivery of print material to the printhead assembly 126. Print material circulates to and from the printhead assembly 126 to maintain homogeneity of the print material while printing proceeds or is paused. Thus, while no print material is being ejected from a nozzle of the printheads of the printhead assembly 126, print material is circulated to and from the printheads 406 to maintain mixing of the print material. A supply tank 502 supplies print material to the printhead assembly 126 and a return tank 504 receives print material from the printhead assembly 126. In this case, both the supply tank 502 and the return tank 504 are located in the supply unit 356 that is attached as part of the printhead assembly 126 and moves with the printheads 406. Print material can also be circulated from the return tank 504 to the supply tank 502 to maintain continuous supply of print material to the printheads 406. Print material circulated from the return tank to the supply tank can be filtered, degassed, and debubbled continuously during recirculation.

At least two loading facilities are provided for loading print material into the system. A large volume system 506 includes a mixed bulk storage vessel 508 and a connection apparatus 510 to connect to, and pressurize, the canister. The large volume system 506 may also support pressurizing a lined canister, such as a NOWPak (Entegris) or other such canister. In some cases, the connection apparatus 510 could be, or could contain, a lined canister. A small volume system supports unloading a gallon bottle using a dip tube arrangement and pressurized clean dry air. The loading facilities are provided in enclosed ventilated compartments accessible from an exterior of the printer, described further below.

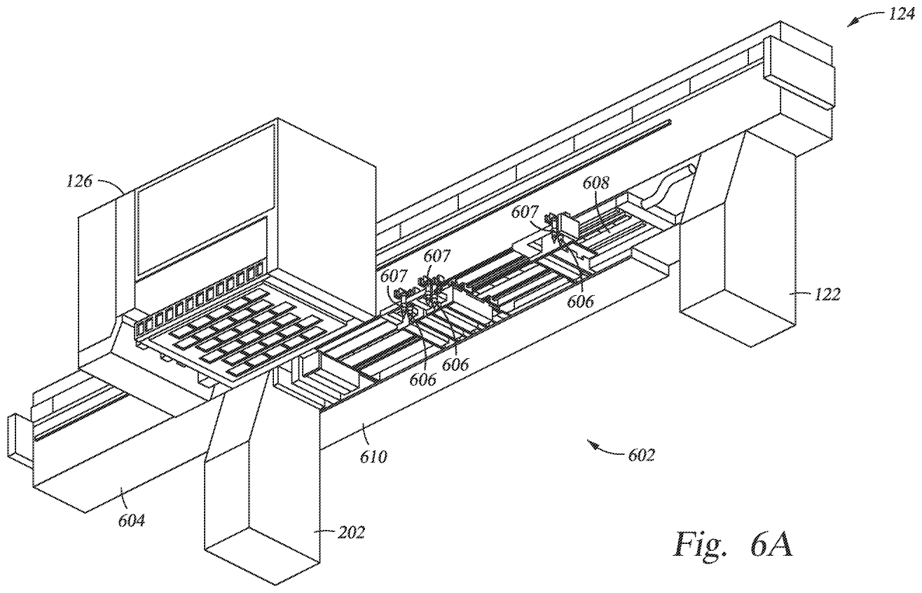

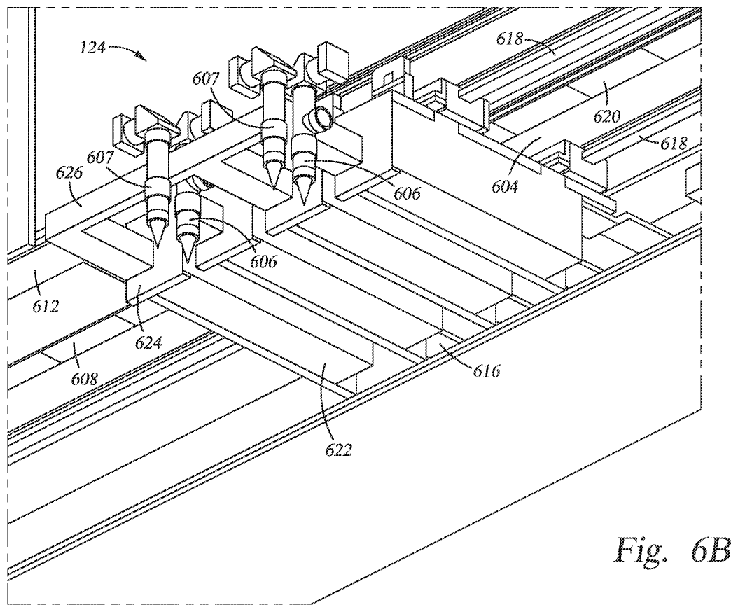

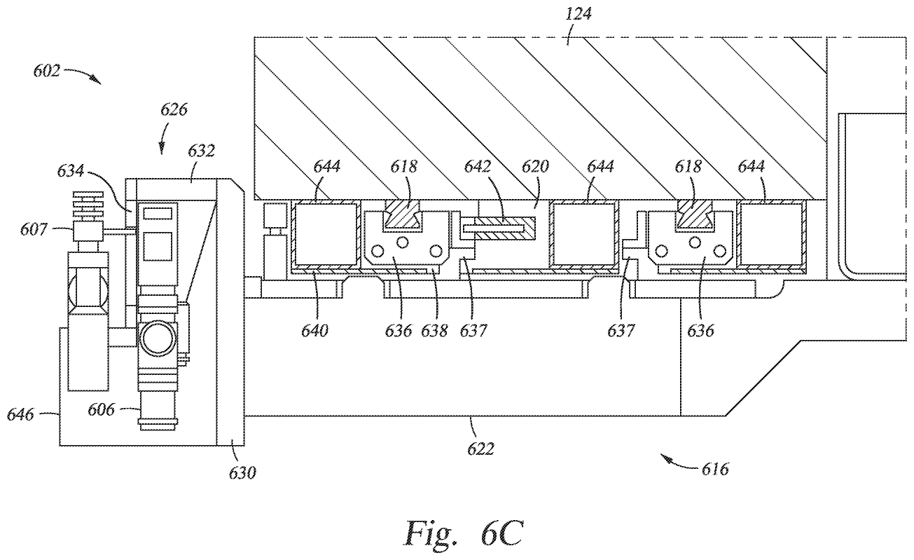

FIG. 6A is a lower perspective view of the print support 124 and the printhead assembly 126. A substrate imaging system 602 is attached to a lower surface 604 of the print support 124. The substrate imaging system 602 is located between the first stand 122 and the second stand 202 in order to access a substrate moved along the substrate support 104 between the first and second stands 122 and 202 below the printhead assembly 126. The substrate imaging system 602 comprises a plurality of imaging devices 606 coupled to a track 608 on the lower surface 604 of the print support 124. As noted above, the printhead assembly 126 is supported by a gas cushion, which is applied to an upper surface and side surface of the print support 124. The imaging devices 606 are arranged to capture images of substrates, or portions of substrates, located in the second section of the substrate support in which printing occurs. The imaging devices 606 are movable along the track 608 to image targeted areas. Each imaging device 606 may individually be a camera, a photosensor, a photosensor array, a line scanner, or any convenient imaging device. In some cases, the plurality of imaging devices 606 includes a wide area camera to “find” a particular feature on a substrate for imaging, and a high magnification camera to capture a high quality image of the feature located by the wide area camera. In other cases, the plurality of imaging devices 606 includes a plurality of line scanners.

A light source 607 is co-located with each imaging device 606. Each light source 607 may individually be any convenient type of light source to illuminate a field of view for imaging by the respective imaging device 606. For example, the light source may be tailored to the type of imaging device or to particular spectral specifications of the associated imaging device. High intensity light sources, such as LEDs, LED arrays, or even laser sources, can be used to deliver an intense, stable, short-duration flash of light for fast imaging. Each light source 607 may individually be a monochromatic, narrow-band, wide-band, or spectral light source, and as implied above, the light sources 607 may all be different in some cases. In other cases, all the light sources 607 may be the same. In still other cases, more than one type of light source can be used where some of the light sources 607 are the same as others and some are different from others.

An enclosure 610 may be provided to capture particles generated by movement of the imaging devices 606 along the track 608. The lower surface 604 of the print support 124 has a first edge 612 toward the first end 110 of the printer 100 (FIG. 1) and a second edge 614 opposite from the first edge 612 toward the second end 112 of the printer 100. In this case, the enclosure is located on the lower surface 604 at the second edge 614 to enclose a movement mechanism (not visible in FIG. 6A) for the imaging devices 606. The imaging devices 606 are supported at a location near the first edge 612 of the lower surface 604. As the imaging devices 606 are moved along the track 604 laterally, particle generation is captured by the enclosure 610, and the particles can be removed. In one case, the enclosure 610 encloses conduits and power cables that service the substrate imaging system 602.

Inclusion of a plurality of imaging devices, which can be different types of devices, enables fast fitting of a print plan to the actual features of a substrate. Because current and future electronic products manufactured using inkjet printing processes can have micron-scale features, extreme precision in printing materials on substrates is needed to construct such products accurately. Very slight misalignment of materials applied to substrates can reduce the performance of such products. The imaging devices herein are used to detect, with extreme precision, the exact positioning, alignment, and shape of the substrate on the substrate support with accuracy and precision below 1 μm. In some cases, multiple electronic products are formed on a single substrate. The imaging devices herein are also used to detect the exact positioning, alignment, and shape of individual product pads on a substrate with accuracy and precision below 1 μm. In many cases, a plurality of features are imaged on a substrate to obtain all the position, alignment, and shape data needed to fit the print plan to the substrate. Using a plurality of imaging devices allows obtaining and processing images to be done substantially in parallel to speed processing.

For example, where the plurality of imaging devices comprises two wide-angle cameras and two high-magnification cameras, the two wide-angle cameras can be used independently, for example simultaneously, concurrently, or non-concurrently, to locate features on the substrate, and the two high-magnification cameras can be used independently, for example simultaneously, concurrently, or non-concurrently, to obtain high quality images of the features. In some cases, precisely positioning high-magnification cameras to obtain high-quality images can take longer than finding features for imaging using wide-area cameras, so there might be more high-magnification cameras than wide-area cameras. For example, in one case there are two wide-area cameras and six high-magnification cameras. While the image processing system of the printer is resolving exact coordinates, relative to a universal printer coordinate system, of the imaged features, the cameras can move to capture additional features. In this way, parallel capture and processing of multiple images speeds up fitting the print plan to the substrate.

FIG. 6B is a detail view of the imaging devices 606. Four imaging devices 606 are visible in the detail view of FIG. 6B to illustrate features that may be incorporated in all the imaging devices 606 of the substrate imaging system 602. The imaging devices 606 are coupled to the track 608 by a traveler 616.

In this case, the track 608 includes two support tracks 618 and an actuator track 620. The actuator here is a magnetic actuator (not visible in FIG. 6B) coupled to the actuator track 620 and to the traveler 616. The support tracks 618 and the actuator track 620 are attached to the lower surface 604 of the print support 124. The traveler 616 is configured as a plurality of support members 622, each of which extends laterally beyond the first edge 612 toward the first end 110 of the printer 100 (FIG. 1) to a support end 624. A mount 626 is attached to the support ends 624 of the support members 622, and the imaging devices 606 are attached to the mount 626. In this way, the imaging devices 606 are located proximate to the first edge 612 but are suspended from the print support 124 at a location spaced apart from the first edge 612 thereof. At this position, one or more of the imaging devices 606 can be used for substrate edge detection to drive some substrate movement and positioning features of the printer 100.

FIG. 6C is a cross-sectional view of the substrate imaging assembly 602. Here, one light source 607, imaging device 606, and support member 622 are visible. The mount 626 has an attachment portion 630 that attaches to the support ends 624 of the support members 622, a first support portion 632 that extends from the attachment portion 630 away from the support ends 624, and a second support portion 634 that extends from the first support portion 632. Here, the imaging device 606 is attached to the first support portion 632 and the light source 607 is attached to the second support portion 634. This results in the imaging device 606 being located between the light source 607 and the support ends 624 of the support members 622. Support for the imaging devices 606 and light sources 607 can be configured in any suitable way.

The traveler 616 is coupled to the support tracks 618 by hangers 636 attached to traveler supports 637 extending through longitudinal openings 638 in a containment plate 640 separating the traveler 616 from the support tracks 618. The openings 638 are longitudinal because they extend along the lower surface 604 of the print support 124 in the longitudinal direction of the print support 124 to support movement of the traveler 616 along the tracks 618 and 620. The actuator track 620 is located between the two support tracks 618. A magnetic actuator 642 is engaged with the actuator track 620 and coupled to one of the traveler supports 637. In some cases, a plurality of magnetic actuators 642 is engaged with the actuator track 620 and coupled to the traveler 616. In such cases, the magnetic actuators may be distributed along the traveler 616 in the longitudinal direction of the print support 124 with uniform or non-uniform spacing. The magnetic actuators 642 and actuator track 620 may define a maglev system in some cases. That is, the magnetic actuators 642 and actuator track 620 may define a magnetic suspension system for the traveler 616. Additionally or alternately, the magnetic actuators 642 and actuator track 620 may define a magnetic positioning system for the traveler 616. Magnetic suspension and positioning may be performed by magnetic induction. In any event, the magnetic actuator(s) 642 and actuator track 620 operate together to propel the traveler(s) 616 along the support tracks 618 and position the traveler(s) at a desired location for the imaging device(s) 606 to capture images.

Exhaust plenums 644 are included between the containment plate 640 and the print support 124 to exhaust any particles generated by movement of the traveler 616. The exhaust plenums 644 have a rectangular profile in this case, but any convenient shape can be used. The exhaust plenums 644 may extend continuously along the lower surface 604 in the longitudinal direction of the print support 124. There are three exhaust plenums shown in FIG. 6C, one for each support track 618 and one for the actuator track 620. In some cases, an exhaust plenum 644 may be discontinuous, which is to say that a plurality of exhaust plenums may be aligned along one support track 618, or along the actuator track 620, with gaps between the exhaust plenums. In this way, an exhaust plenum assembly comprising a plurality of aligned exhaust plenums may be used to exhaust each element.

A gas movement system (not shown) is configured to direct gas flow into and through the exhaust plenums 644 to gather any particles from the substrate imaging system 602 (i.e. from movement of the travelers 616 along the tracks 618 and 620) into the exhaust plenums 644 and remove the particles. Particle-generating members of the substrate imaging system 602 are thus ventilated to control particles. A particle shield 646 may also enclose the imaging devices 606, and optionally, the light sources 607, with an opening provided in each particle shield 646 to facilitate imaging portions of the substrate. An interior of the particle shield may be fluidly coupled to one of the exhaust plenums 644.

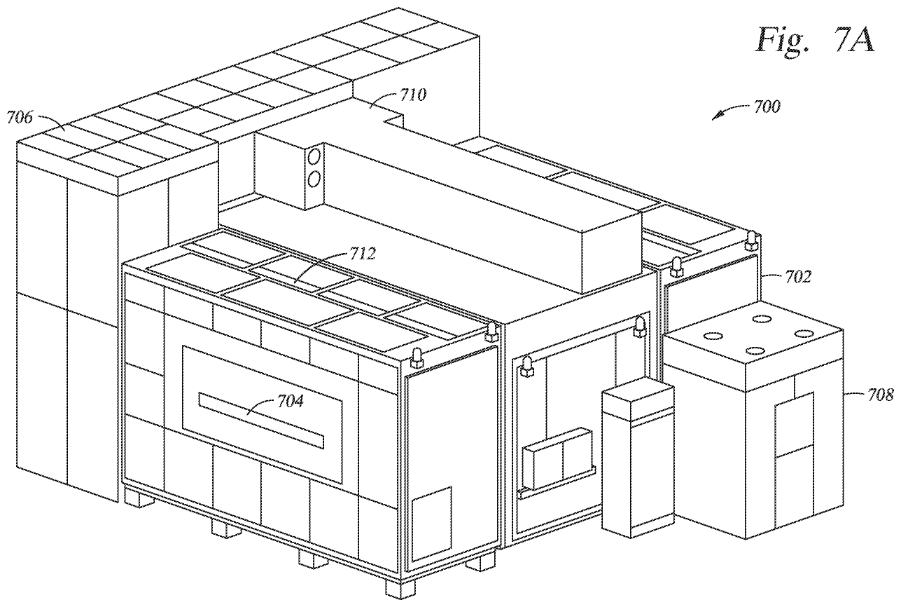

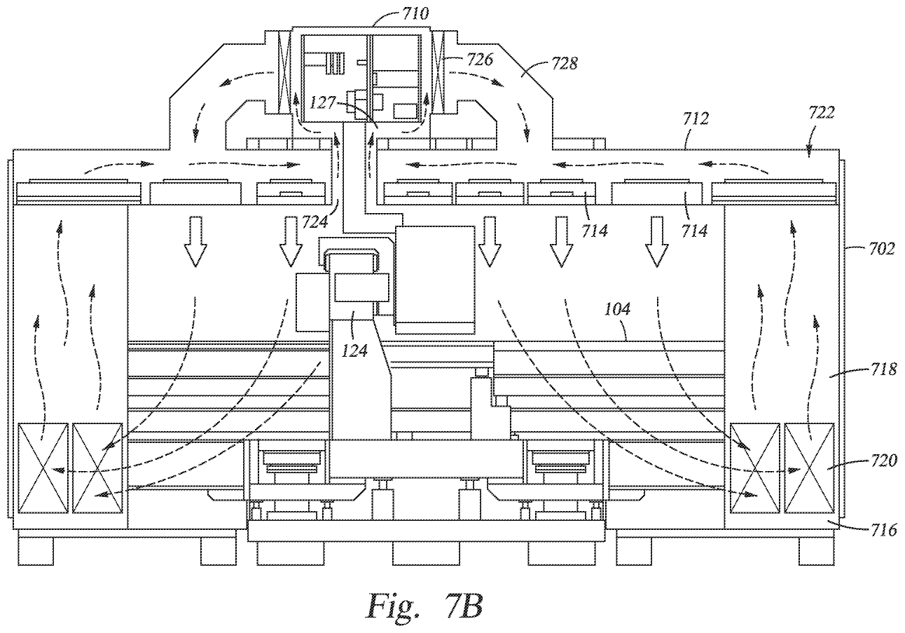

Commensurate with the discussion above, extreme and pervasive particle control is provided for the printer 100. FIG. 7A shows a containment structure 700 of the printer 100 (FIG. 1). The printer is disposed in a print enclosure 702, viewed here with a substrate inlet port 704 visible. An access structure 706 is coupled to the enclosure 702 along the second side 125 of the substrate support 104 (FIG. 1), and an odor booth 708 encloses a print material loading area along the first side 123 of the substrate support 104, near the second end 112 of the printer 100. A separate printhead supply assembly enclosure 710 is provided above, and coupled to, the print enclosure 702. The printhead supply assembly enclosure 710 extends to the access structure 706 to provide access to the printhead supply assembly 128 (FIG. 1) for maintenance. A fan unit 712, or in some cases a plurality of fan units 712, is located between the printhead supply assembly (and enclosure 710 thereof) and the print enclosure 702 to drive circulation of gas through the print enclosure 702 and the printhead supply assembly enclosure 710.

FIG. 7B is a schematic cross-sectional view of the printer 100 illustrating gas flow within the printer during operation. The fan unit 712 comprises a plurality of fan filter units 714 that filter gas and drive gas into the print enclosure 702 toward the substrate support 104. Gas flows around the substrate support 104 to lower corners 716 of the print enclosure 702 to return ducts 718 located at the corners 716 of the print enclosure 702. One or more temperature control units 720 is located within each corner return duct 718. The corner return ducts 718 receive gas at a lower portion and exhaust gas at an upper portion into the fan unit 712. The fan unit 712 includes a plenum 722 that encloses the fan filter units 714 and provides gas supply to the fan filter units 714. The plenum 722 of the fan unit 712 extends along and above an upper portion of the print enclosure 702, and is fluidly coupled to the corner return ducts 718 to receive return gas. The gas flows through the fan unit plenum 722 to the fan filter units 714 for filtration and circulation.

The fan unit 712 includes a central return duct 724 with a longitudinal axis along the x axis, which is parallel to the longitudinal axis of the print support 124. The central return duct 724 fluidly couples an interior of the print enclosure 702 to an interior of the printhead supply assembly enclosure 710. The conduit connected to the printhead supply assembly 128 and the printhead assembly 126 is disposed through the central return duct 724. Gas is withdrawn through the central return duct 724 into the printhead supply assembly enclosure 710, located above the fan unit 712, to ventilate the printhead supply assembly 128 and auxiliary support 127. Gas is withdrawn from the printhead supply assembly enclosure 710 through one or more filters 726 and returned to the fan unit plenum 722 through upper conduits 728. Thermal control units may be included the upper conduits 728. Drive units may also be included in the upper conduits 728. Here, there are two upper conduits 728 shown. In other versions, there may be only one upper conduit 728, or there may be a plurality of upper conduits 728 at various locations along the length of the printhead supply assembly enclosure 710. In the case of FIG. 7B, the upper conduits 728 are located at an end of the printhead supply assembly enclosure 710 nearest the access structure 706 (FIG. 7A).

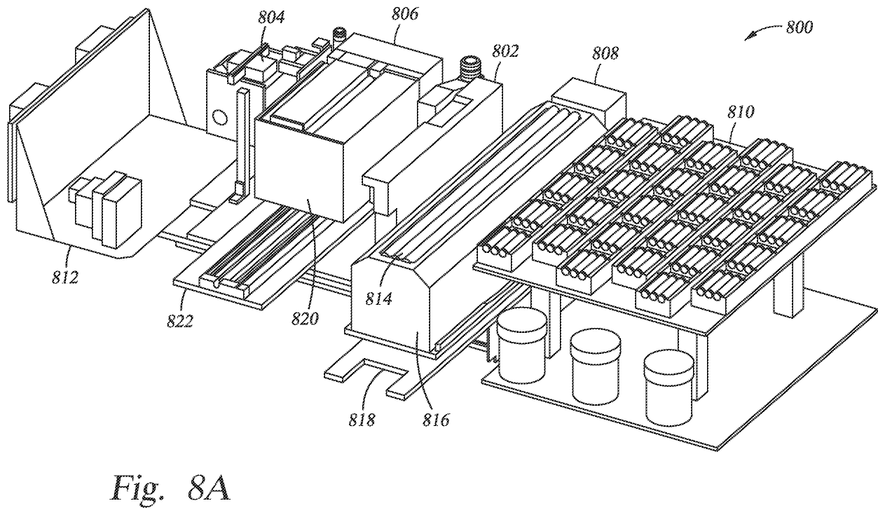

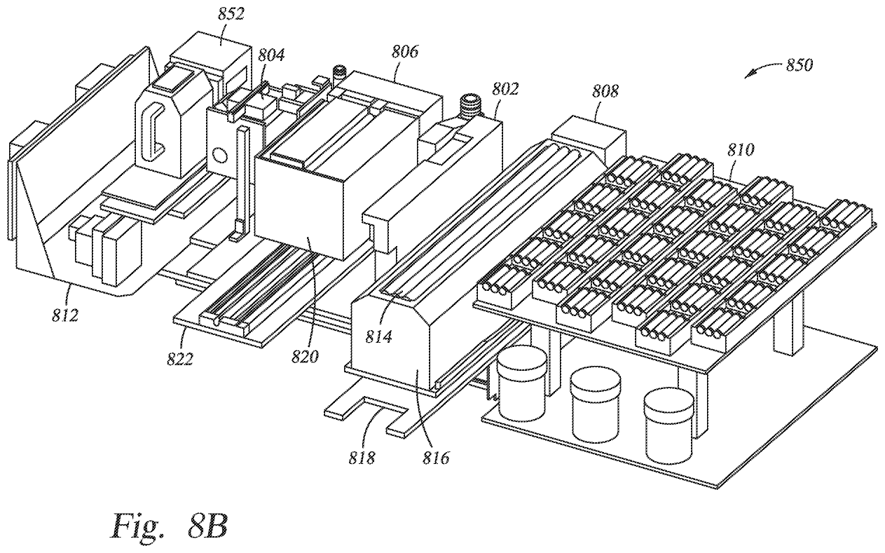

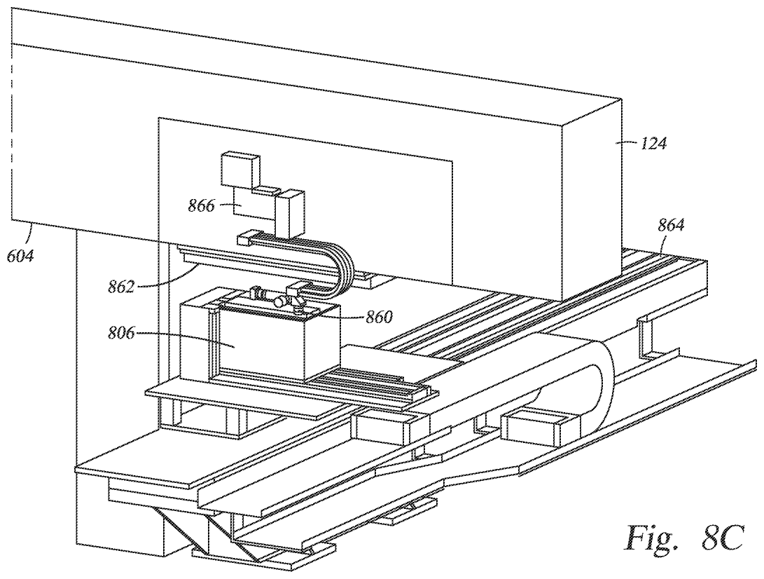

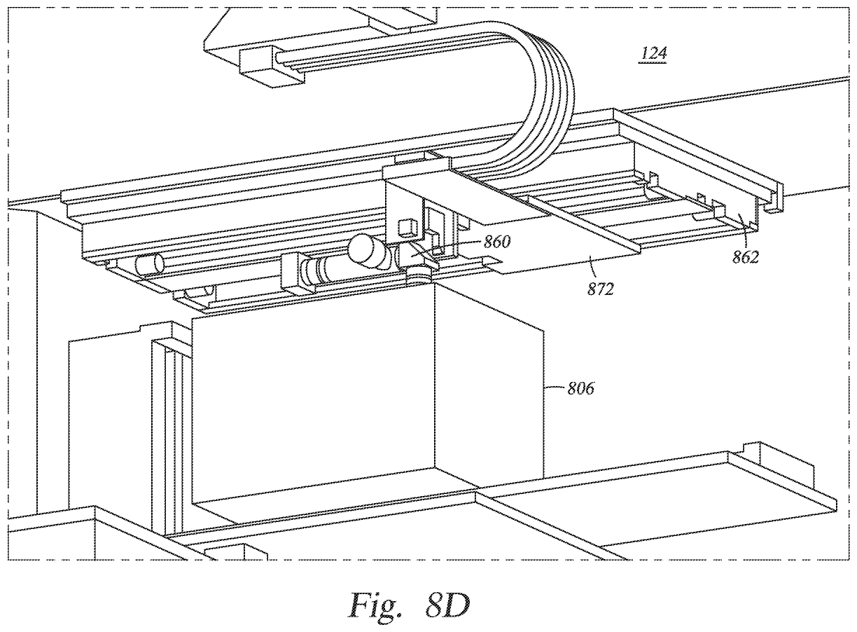

FIG. 8A shows a diagnostic unit 800 of the printer 100. In the version of FIG. 1, the diagnostic unit 800 is located along the second side 125 of the substrate support 104 (FIG. 1) proximate to the second stand 202 (FIG. 2) in a position for printing engagement with the printhead assembly 126. In other embodiments, the diagnostic unit 800 can be placed in any convenient location, but is generally located such that the printhead assembly 126 (or other similar unit) can access the diagnostic unit 800. In this case, the printhead assembly 126 moves along the print support 124 to the second side 125 of the substrate support 104 to engage with the diagnostic unit 800.

The diagnostic unit includes a drop watcher 802, a drop inspector 804, a drop placement analyzer 806, a cleaner 808, a purge unit 810, and an electronics unit 812 to drive the diagnostic unit 800. The drop watcher 802 analyzes trajectory and volume of drops dispensed from the printheads while the drops are in flight using illumination and light analysis such as interferometry or shadowgraphy. The drop inspector 804 analyzes drop volume and shape using reflected and refracted light. The cleaner 808 has a wiping substrate 814 that is brought into contact with a printhead or tile to wipe off any debris attached to the printhead or tile onto the wiping substrate 814. The wiping substrate 814 is supplied on a supply roll (not shown) that is spooled from the supply roll to a cleaning position and then to an uptake roll (not shown). The supply and uptake roll are included in a cartridge 816 that is movable along a rail 818 for replacement. The purge unit 810 provides catchment for any print material purged through a printhead (or all the printheads at once, if necessary).

The drop placement analyzer 806 has a test substrate on which drops are deposited. The deposited drops are photographed using high resolution photography and strobed or flashed light sources to accurately determine the positions of the deposited drops. The test substrate is provided on a roll (not shown) that is loaded into a removable cartridge 820 of the drop placement analyzer 806. The cartridge 820 is shown here without the test substrate for simplicity of explanation. The test substrate is spooled out to a print area of the analyzer and then onto an uptake roll of the cartridge 820. When the test substrate is exhausted, the cartridge 820 is removed and a new cartridge 820, with new test substrate, installed. The cartridge 820 is movable along a rail 822 of the drop placement analyzer 806. The test substrate is a flexible material to facilitate deployment through the drive mechanisms of the analyzer 806, and is typically made of a material selected to provide a suitable background for high resolution photography. In some cases, the material is reflective. For example, in some cases the test substrate comprises a receiving film, which may be transparent and may be a polymeric material, attached to a metal backing.

FIG. 8B shows another embodiment of a diagnostic analyzer 850. The analyzer 850 has all the units that the analyzer 800 has, along with a second cleaner 852. The second cleaner 852 has a similar function to the cleaner 808, but with a different format. Where the wiping substrate 814 has a length sized to wipe multiple groups of printheads, for example multiple tiles such as the tiles 302, the second cleaner 852 has a second wiping surface 854 sized to wipe only one tile. In concept, two or more cleaners can be included in a diagnostic analyzer to address areas encompassing different numbers of printheads to provide options for cleaning that can optimize printer throughput.

Regarding the drop placement analyzer 806, an imaging unit is used to photograph the drops deposited on the test substrate. The imaging unit is attached to the print support, and may be a camera, for example a CCD device, or other imaging apparatus. FIG. 8C shows a view of the drop placement analyzer 806 and a camera to be used with the drop placement analyzer 806. The other components of the diagnostic unit 800 or 850 are omitted to simplify explanation. A drop placement camera 860 is attached to a linear support 862, which in turn is attached to the lower surface 604 of the print support 124. The drop placement camera 860 is oriented in an operative relationship to the test substrate of the analyzer 806 to facilitate capturing images of drops deposited on the test substrate by printheads of the printhead assembly 126 (not visible in FIG. 8C). The drop placement camera 860 is movable along the linear support 862 to facilitate photographing all drops deposited on the test substrate of the analyzer 806. A high-intensity strobed or flashed light source can be used to illuminate the drops to provide fast, high-resolution, imaging.

The diagnostic unit, comprising any or all of the components of the diagnostic units 800 and 850, may be disposed on a diagnostic unit track 864 to position various components of the diagnostic unit for engagement with the printhead assembly 126. The diagnostic unit track 864 is oriented along the y axis direction (FIG. 1) so the various units can be moved into engagement with the printhead assembly 126, which may be effectively parked in a diagnostic position along the print support 124. The diagnostic unit rests on a motorized carriage 866 that engages with the diagnostic unit track 864 to transport the diagnostic unit to positions for engaging various components of the diagnostic unit with the printheads. An imaging electronic unit 866 is attached to the print support 124, in this case to a side of the print support 124 facing the second end 112 of the printer 100. A mounting plate 868 is provided to attach the imaging electronic unit 866 to the print support 124. A gap 870 between an edge of the mounting plate 868 and an upper surface 872 of the print support 124 allows the gas supports 354 of the printhead carriage 352 (FIG. 3D) uninterrupted engagement with the surface of the print support 124 as the printhead assembly 126 moves into engagement with the diagnostic unit.

FIG. 8D is a perspective detail upward view of the drop placement analyzer 806 positioned to engage with the drop placement camera 860. The camera 860 is coupled to the linear support 862 by a carriage 872 that engages with the linear support 862 to support and transport the camera 860 along the linear support 862. The camera 860 can thus be moved along the length of the test substrate (not shown) of the analyzer 806, and the analyzer 806 can be moved to expose the entire width of the test substrate to the camera 860.

In operation, the printhead assembly 126 moves to a diagnostic position where components of the diagnostic unit 800 or the diagnostic unit 850 can engage with the printheads of the printhead assembly 126. The diagnostic unit moves to engage a desired component with the printheads. Thus, the printhead assembly 126 moves in the x-axis direction and the diagnostic unit moves in the y-axis direction into mutual engagement. The printheads interact with one or more components of the diagnostic unit, which moves to facilitate the desired engagements. The printhead assembly 126 then moves away from the diagnostic unit and can resume other functions, such as printing on substrates. Where the diagnostic unit has collected data from direct engagement with the printheads, the data is routed to any suitable disposition, such as storage or processing.

Where the printheads have deposited print material on the test substrate of the drop placement analyzer 806, the diagnostic unit 800 or 850 moves along the y-axis direction, and the drop placement camera 860 moves along the x-axis direction into mutual engagement. Actuation of both the drop placement analyzer 806 and the drop placement camera 860 enables the camera and the analyzer to be mutually scanned while images of the test substrate are captured, thus accelerating acquisition of drop placement data. A strobed or flashed light source can be used to minimize any distortion due to movement of the camera or the analyzer during image capture. The captured images can be analyzed to determine exact characteristics of drop ejection and placement from each nozzle of every printhead in the printhead assembly 126.

While the foregoing is directed to embodiments of one or more inventions, other embodiments of such inventions not specifically described in the present disclosure may be devised without departing from the basic scope thereof, which is determined by the claims that follow.

1. An inkjet printer, comprising:
a massive base disposed on a flotation support;
a flotation substrate support disposed on the base;
a print support comprising a printhead assembly support and an auxiliary support;
a printhead assembly coupled to the printhead assembly support; and
a printhead supply assembly coupled to the auxiliary support.

2. The inkjet printer of claim 1, further comprising a substrate rotation assembly coupled to the substrate support.

3. The inkjet printer of claim 1, further comprising a gas filtration and circulation unit disposed between the printhead assembly support and the auxiliary support.

4. The inkjet printer of claim 3, further comprising a print enclosure enclosing the substrate support and the printhead assembly.

5. The inkjet printer of claim 4, further comprising a print supply enclosure enclosing the print supply assembly and the auxiliary support.

6. The inkjet printer of claim 5, wherein the gas filtration and circulation unit is disposed between the print supply enclosure and the print enclosure.

7. The inkjet printer of claim 2, wherein the substrate rotation assembly includes a first linear actuator coupled to a first linear support extending along a first axis of the inkjet printer and a second linear actuator coupled to a second linear support extending along a second axis of the inkjet printer perpendicular to the first axis.

8. The inkjet printer of claim 2, wherein each of the first and the second linear actuator includes a rotatable attachment member for attaching to a substrate to be rotated by the substrate rotation assembly.

9. The inkjet printer of claim 1, wherein the printhead assembly comprises a plurality of print tiles arranged in rows, each print tile having a fluid member and an electronic member that fit together to form the tile.

10. The inkjet printer of claim 9, wherein the fluid member includes a plurality of printheads at a first end of the fluid member and a fluid connector at a second end of the fluid member, opposite from the first end, and a supply conduit and a return conduit that each extends from the printheads to the fluid connector, and the electronic member includes a digital unit, and wherein, when the fluid member and the electronic member are assembled into a print tile, the supply conduit and the return conduit are disposed on opposite sides of the digital unit.

11. An inkjet printer, comprising:
a massive base disposed on a flotation support;
a flotation substrate support disposed on the base;
a print support comprising a printhead assembly support and an auxiliary support;
a plurality of imaging devices movably coupled to a linear track mounted to the printhead assembly support;
a printhead assembly coupled to the printhead assembly support; and
a printhead supply assembly coupled to the auxiliary support.

12. The inkjet printer of claim 11, further comprising a substrate rotation assembly coupled to the substrate support.

13. The inkjet printer of claim 11, wherein each imaging device is coupled to the linear track by a traveler.

14. The inkjet printer of claim 13, further comprising a containment plate between the traveler and the printhead assembly support and a magnetic actuator coupled to the traveler and disposed between the containment plate and the printhead assembly support.

15. The inkjet printer of claim 14, further comprising an exhaust plenum disposed between the containment plate and the printhead assembly support.

16. The inkjet printer of claim 11, further comprising a gas filtration and circulation unit disposed between the printhead assembly support and the auxiliary support, a print enclosure enclosing the substrate support and the printhead assembly, a print supply enclosure enclosing the print supply assembly and the auxiliary support, wherein the gas filtration and circulation unit is disposed between the print supply enclosure and the print enclosure, and a conduit fluidly coupling the print supply enclosure to the gas filtration and circulation unit.

17. The inkjet printer of claim 11, further comprising a diagnostic unit disposed at a side of the substrate support in a position to interact with the printhead assembly, the diagnostic unit comprising a drop placement analyzer, and an imaging unit coupled to the printhead assembly support and oriented to image drops disposed on the drop placement analyzer.

18. The inkjet printer of claim 17, wherein the diagnostic unit further comprises one or more of a drop inspector, a drop watcher, a cleaner, and a purge unit.

19. An inkjet printer, comprising:
a massive base disposed on a flotation support;
a flotation substrate support disposed on the base;
a print support comprising a printhead assembly support and an auxiliary support;
a plurality of imaging devices movably coupled to a linear track mounted to the printhead assembly support;
a printhead assembly coupled to the printhead assembly support, the printhead assembly comprising a housing enclosing a supply unit at a first end of the housing and a plurality of print tiles at a second end of the housing; and
a printhead supply assembly coupled to the auxiliary support.

20. The inkjet printer of claim 19, wherein the supply unit comprises a supply reservoir and a return reservoir, and each print tile has a fluid member and an electronic member that fit together to form the tile.
